(19) United States
(12) Patent Application Publication
(10) Pub. No.: US 2012/0021726 A1
(43) Pub. Date: Jan. 26, 2012

(54) MULTI-CARD MOBILE TERMINAL AND METHOD FOR RECEIVING SYSTEM MESSAGES THEREOF

(75) Inventor: Jie Fu, Shanghai (CN)

(73) Assignee: Spreadtrum Communications (Shanghai) Co., Ltd., Shanghai (CN)

(21) Appl. No.: 13/104,751

(22) Filed: May 10, 2011

(30) Foreign Application Priority Data
Jul. 23, 2010 (CN) 201010240576.7

(51) Int. Cl. H04W 4/00

(52) U.S. Cl. 455/412.1

(57) ABSTRACT

The invention provides a method for receiving system messages for a multi-card mobile terminal comprising: acquiring system messages received by any user identity card of a multi-card mobile terminal from network; and storing the system messages in a buffer, so that each user identity card acquires the system messages from the buffer directly. The invention resolves the problem that a plurality of user identity cards receiving same system messages repeatedly brings about high system cost and decreasing the time for network selection and cell reselection.

### CROSS REFERENCE TO RELATED APPLICATIONS

The present application claims the priority of Chinese Patent Application No. 201010240576.7, entitled “A light emitting device and a manufacturing method thereof”, and filed Jul. 23, 2010, the entire disclosure of which is incorporated herein by reference.

### FIELD OF THE INVENTION

The present invention relates to mobile communication technology, and particularly relates to a multi-card mobile terminal and a method for receiving system messages thereof.

### BACKGROUND OF THE INVENTION

With the rapid development of mobile communication technology, Goble System for Mobile communication (GSM) network has been widely used. GSM users may have several numbers; therefore, a plurality of mobile terminals (for example, mobile telephones) sustain two or more Subscriber Identity Module (SIM) cards simultaneously, for meeting the subscribers' demand for multi-SIM cards standby at the same time.

Nowadays, multi-card mobile terminals is divided into two types: one is provided with multi-GSM modules, and each GSM module includes a SIM card, wherein all the SIM cards are in a standby mode at the same time and each SIM card can be called or perform a calling independently; in a word, the kind of multi-card mobile terminals is based on multi-GSM modules and each GSM module includes a SIM card. The other is provided with a GSM module and multi-SIM cards, and all the SIM cards are in a standby mode at the same time by using time sharing multiplex technology; however, just one SIM card can be called or perform a calling at the same time; in other words, the kind of multi-card mobile terminals is based on single-GSM module and the GSM module includes multi-SIM cards.

In GSM network, a mobile terminal in a standby mode repeatedly receives system messages sent from a base station to determine the current location, current network parameters and the type of services which the mobile terminal is able to acquire. Besides, the system messages are also used for network selection when the mobile terminal is switched on and for cell reselection when the mobile terminal is in a standby mode, and so on. In the prior art, different SIM cards of a multi-SIM cards mobile terminal receive system messages independently when the multi-SIM cards mobile terminal is switched on or in the standby mode, thereby increasing the system cost and prolonging the time for network selection when the multi-SIM cards mobile terminal is switched on and cell reselection when the multi-SIM cards mobile terminal is in the standby mode.

Chinese patent application No. 200710171901.7 discloses a network selecting method for a dual-SIM cards mobile telephone while being switched on, but the problems described above are still not resolved.

### SUMMARY OF THE INVENTION

An object of the present invention is to provide a multi-card mobile terminal and a method for receiving system messages thereof, thereby decreasing the system cost and reducing the time for selecting network and cell reselection.

To achieve the object, the present invention provides a method for receiving system messages for a multi-card mobile terminal, comprising:

acquiring system messages received by any user identity card of a multi-card mobile terminal from network; and

storing the system messages in a buffer, so that each user identity card acquires the system messages from the buffer directly.

Optionally, the method for receiving system messages for a multi-card mobile terminal further comprises classifying the system messages before storing the system messages, so that one kind of system messages is stored in the buffer only once.

Optionally, the method for receiving system messages for a multi-card mobile terminal further comprises setting a period of validity for the system messages stored in the buffer; and the user identity cards acquiring the system messages from the buffer comprises the user identity cards acquiring the system messages from the buffer in the period of validity.

Optionally, the user identity cards are SIM cards and the period of validity is five minutes.

Optionally, the method for receiving system messages for a multi-card mobile terminal further comprises: if the period of validity has expired, any user identity card acquires real-time system messages from the network.

Optionally, the method for receiving system messages for a multi-card mobile terminal further comprises: updating the system messages in the buffer according to the real-time system messages.

Optionally, the updating of system messages comprises replacement or amendment.

Optionally, the method for receiving system messages for a multi-card mobile terminal further comprises: classifying the real-time system messages before updating the system messages, so that one kind of system messages is updated in the buffer only once during the period of validity.

Optionally, the multi-card mobile terminal is a triple-card triple-standby mobile terminal.

To achieve the object, the present invention provides a multi-card mobile terminal comprising:

an acquiring unit for acquiring system messages received by any user identity card from a network; and

a storing unit for storing the system messages acquired by the acquiring unit in a buffer, so that each user identity card acquires the system messages from the buffer.

Optionally, the multi-card mobile terminal further comprises a first classifying unit for classifying the system messages before the system messages is stored and controlling the storing unit to store one kind of system messages only once.

Optionally, the multi-card mobile terminal further comprises a setting unit for setting a period of validity for the system messages and a transmitting unit for transmitting the system messages to the user identity cards in the period of validity.

Optionally, the user identity cards are SIM cards and the period of validity is five minutes.

Optionally, if the period of validity has expired, the acquiring unit acquires real-time system messages received by any user identity card from the network, and the transmitting unit transmits the real-time system messages to the user identity cards.

Optionally, the storing unit updates the system messages in the buffer according to the real-time system messages.

Optionally, the updating of system messages comprises replacement or amendment.

Optionally, the multi-card mobile terminal further comprises a second classifying unit for classifying the real-time system messages before the system messages is updated and controlling the storing unit to update one kind of system messages only once.

Optionally, the multi-card mobile terminal is a triple-card triple-standby mobile terminal.

In comparison with conventional technologies, the present invention has the following advantages:

The present invention stores system messages received by any user identity card into a buffer, so that each user identity card is able to acquire system messages from the buffer directly, thereby resolving the problem that different user identity cards receiving system messages repeatedly brings about high system cost and decreasing the time for network selection and cell reselection.

In addition, a period of validity is set on the system messages in the buffer. In the period of validity, a plurality of user identity cards share the system messages in the buffer; if the period of validity has expired, the system messages in the buffer are updated according to real-time system messages acquired from the network, which avoids the problem that the system messages in the buffer are expired and improve the reliability of the system messages.

Furthermore, the present invention classifies the system messages received by the user identity cards and one kind of system messages only has one copy in the buffer, therefore, the memory space occupied by the buffer is reduced and the system cost is decreased.

### BRIEF DESCRIPTION OF THE DRAWINGS

FIG. 1 is a schematic view of a method for receiving system messages for a multi-card mobile terminal in the first embodiment;

FIG. 2 is a basic structural view of a multi-card mobile terminal being connected to a plurality of SIM cards in the first embodiment;

FIG. 3 is a detailed structural view of a multi-card mobile terminal being connected to a plurality of SIM cards in the first embodiment.

### DESCRIPTION OF THE PREFERRED EMBODIMENTS

In the prior art, different SIM cards of a multi-SIM cards mobile terminal receive system messages independently when the multi-SIM cards mobile terminal is switched on or in the standby mode, thereby increasing the system cost and prolonging the time for network selection when the multi-SIM cards mobile terminal is switched on and cell reselection when the multi-SIM cards mobile terminal is in the standby mode.

The present invention puts system messages received by any user identity card of a multi-card mobile terminal into a buffer, so that each user identity card is able to acquire system messages from the buffer directly, thereby resolving the problem that different user identity cards receiving same system messages repeatedly brings about high system cost and decreasing the time for network selection and cell reselection.

Hereunder, the present invention will be described in detail with reference to embodiments, in conjunction with the accompanying drawings.

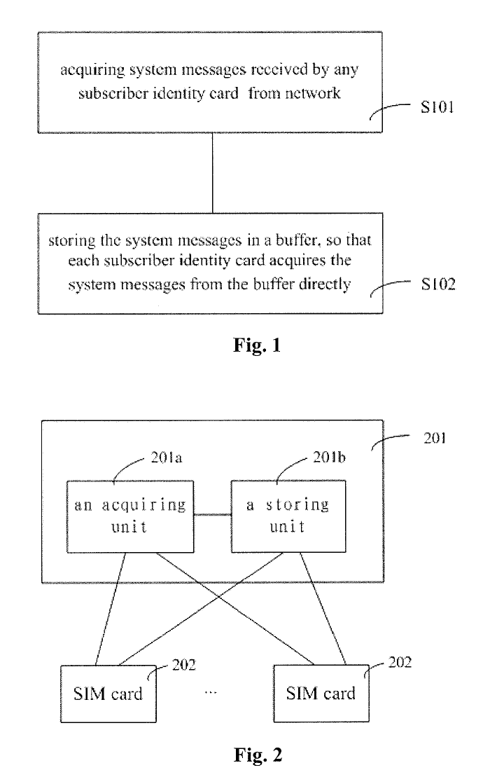

FIG. 1 is a schematic view of a method for receiving system messages for a multi-card mobile terminal in the first embodiment. Referring to FIG. 1, the method comprises: a step S101, acquiring system messages received by any user identity card of a multi-card mobile terminal from network; a step S102, storing the system messages in a buffer, so that each user identity card is able to get system messages from the buffer directly.

According to this embodiment, the multi-card mobile terminal is in accordance with the GSM standard, and the subscriber identity card is a SIM card. However, the invention is not only for the GSM standard, but also for other mobile communication standards, such as the TD-SCDMA standard, correspondingly, the user identity card is a USIM card.

FIG. 2 is a basic structural view of a multi-card mobile terminal being connected to a plurality of SIM cards in the first embodiment. The multi-card mobile terminal 201 is connected to a plurality of SIM cards 202, for example, the number of the SIM cards 202 is two, three or four. According to this embodiment, the multi-card mobile terminal 201 is a triple-card triple-standby mobile terminal and is able to support three SIM cards in the standby mode at the same time. After the multi-card mobile terminal 201 is switched on, every SIM card 202 is in the standby mode. While the multi-card mobile terminal 201 is searching network in the switching on process and in the standby mode after being switched on, every SIM card 202 receives system messages from a base station, wherein the system messages are sent in two ways, one is broadcast message, and the other is associated message. System messages comprises a plurality of types, for example, system message 1, system message 2, system message 2bis, system message 2ter, system message 3, and so on; each type of system messages comprise corresponding contents, for example, system message 1 comprises descriptions about cell channel and control parameters of random access channel, system message 2 comprises descriptions about neighboring cells, network color code permitted and control parameters of random access channel, and system message 3 comprises cell identification, location identification, descriptions about control channel, residential options, cell selection parameters, control information about random access channel, and so on.

According to the embodiment, the multi-card mobile terminal 201 comprises: an acquiring unit 201a for acquiring system messages received by any SIM card 202 from the network; and a storing unit 201b for storing the system messages in a buffer (not shown in the figure), where each SIM card 202 gets the system messages. The buffer is a memory integrated in the storing unit 201b or a separate memory which is under the read-write control by the storing unit 201b. The acquiring unit 201a comprises a radiofrequency (RF) module, which is connected to each SIM card 202, shared by the SIM cards 202 and connecting the SIM cards 202 to the GSM network.

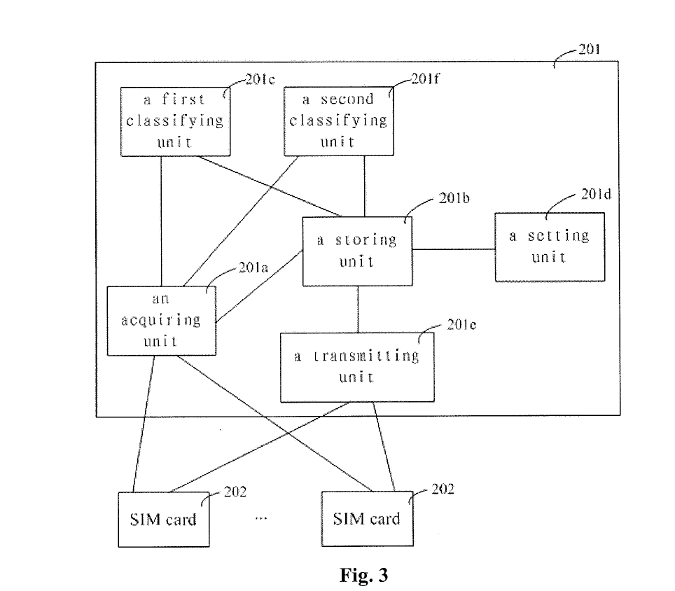

FIG. 3 is a detailed structural view of a multi-card mobile terminal being connected to a plurality of SIM cards in the first embodiment. Referring to FIG. 1 and FIG. 3, hereinafter is a detailed description on a receiving process of a multi-card mobile terminal and system messages.

A step S101 is acquiring system messages received by each user identity card from the network. In the process of switching on or in the standby mode, the acquiring unit 201a connects any SIM card 202 which occupying the RF module to the GSM network, receives system messages and transmits the system messages to the storing unit 201b, wherein the storing unit 201b stores the system messages in the buffer, whereby any SIM card 202 (including the SIM card which receives system messages from the network and other SIM cards) is able to acquire the system messages from the buffer directly. The multi-card mobile terminal 201 further comprises a first classifying unit 201c for classifying the system messages before storing the system messages which are acquired by the acquiring unit 201a and outputting the classification result. The storing unit 201b is under the control of the first classifying unit 201c, specifically, the storing unit 201b stores one kind of system messages in the buffer only once according to the classification result outputted by the first classifying unit 201c; in other words, one kind of system messages has only one copy stored in the buffer. For example, in GSM standard in every 408 frames, system message 1 and system message 2 are received only once respectively, and system message 3 and system message 4 are received twice respectively; therefore, the first classifying unit 201c classifies the system messages which are acquired by the acquiring unit 201a, in order that one kind of system messages only has one copy in the buffer, on other words, no repeated system messages are stored in the buffer at one time, which avoids occupying large amount of storage space because of storing the same system messages repeatedly and further reduces the system cost.

In the process of switching on, after one SIM card 202 ends searching the network, the corresponding system messages are stored in the buffer by the storing unit 201b, so that every SIM card 202 is able to acquire the corresponding system messages from the buffer directly when they are searching the network, which avoids the system cost that is created by acquiring system messages from the network and reduces the total time that is cost by every SIM card searching the network. Similarly, in the standby mode, every SIM card 202 shares the system messages stored in the buffer, which reduces the system cost that is created by every SIM card 202 receiving system messages respectively and resolves the problem that the cell reselection time is too long.

A step S102 is storing the system messages in the buffer and setting a period of validity for the system messages stored in the buffer. According to one embodiment, the multi-card mobile terminal 201 further comprises a setting unit 201d and a transmitting unit 201e, wherein the setting unit 201d is for setting a period of validity for the system messages. In the period of validity, the system messages in the buffer is credible; when each SIM card 202 acquires system messages, the system messages are transmitted to the corresponding SIM card directly by the transmitting unit 201e, which is used for selecting network while being switched on or receiving system messages in the standby mode, wherein the system messages are transmitted to the SIM card by the transmitting unit 201e on its own initiative or the SIM card acquires the system messages from the buffer through the transmitting unit 201e. If the period of validity has expired, the SIM cards 202 acquire real-time system messages from the network through the acquiring unit 201a, and the storing unit 201b updates the system messages in the buffer according to the real-time system messages. Specifically, the storing unit 201b replaces or amends the system messages in the buffer whose period of validity has expired according to the real-time system messages and adds new period of validity. Setting a period of validity is a good way to avoid the problem that some system messages stay in the buffer for a long time and expire, resulting in that the system messages received by the SIM cards 202 are not real-time and the reliability of the whole system is reduced. In the GSM standard, the system messages of a neighboring cell is valid for five minutes, therefore, said period of validity is five minutes.

In addition, the multi-card mobile terminal 201 further comprises a second classifying unit 201f according to the embodiment. The second classifying unit 201f is for classifying the system messages in the buffer before being updated and outputting the classification result. The storing unit 201b is under the control of the second classifying unit 201f, specifically, the storing unit 201b updates one kind of system messages in the buffer only once according to the classification result outputted by the second classifying unit 201f; in other words, only one copy can be got in the buffer at one time.

In conclusion, system messages received by a SIM card of a multi-card mobile terminal of the present invention is stored in a buffer, so that each SIM card is able to acquire system messages from the buffer directly, thereby resolving the problem that different SIM cards receiving system messages repeatedly brings about high system cost and decreasing the time for network selection and cell reselection.

Furthermore, a period of validity is set on the system messages in the buffer, which avoids the problem that the system messages in the buffer are expired and improve the reliability of the system messages.

Although the present invention has been disclosed as above with reference to preferred embodiments thereof but will not be limited thereto. Those skilled in the art can modify and vary the embodiments without departing from the spirit and scope of the present invention. Accordingly, the scope of the present invention shall be defined in the appended claims.

1. A method for receiving system messages for a multi-card mobile terminal, comprising:
acquiring system messages received by any user identity card of a multi-card mobile terminal from network; and
storing the system messages in a buffer, in such a way that each user identity card acquires the system messages from the buffer directly.

2. The method for receiving system messages for a multi-card mobile terminal of claim 1, further comprising classifying the system messages before storing the system messages, one kind of system messages being stored in the buffer only once.

3. The method for receiving system messages for a multi-card mobile terminal of claim 1, further comprising setting a period of validity for the system messages stored in the buffer; and
the user identity cards acquiring the system messages from the buffer comprises the user identity cards acquiring the system messages from the buffer in the period of validity.

4. The method for receiving system messages for a multi-card mobile terminal of claim 3, wherein the user identity cards are SIM cards and the period of validity is five minutes.

5. The method for receiving system messages for a multi-card mobile terminal of claim 3, further comprising: if the period of validity has expired, any user identity card acquires real-time system messages from a network.

6. The method for receiving system messages for a multi-card mobile terminal of claim 5, further comprising: updating the system messages in the buffer according to the real-time system messages.

7. The method for receiving system messages for a multi-card mobile terminal of claim 6, wherein the updating of system messages comprises replacement or amendment.

8. The method for receiving system messages for a multi-card mobile terminal of claim 6, further comprising: classifying the real-time system messages before updating the system messages, one kind of system messages being updated in the buffer only once during the period of validity.

9. The method for receiving system messages for a multi-card mobile terminal of claim 1, wherein the multi-card mobile terminal is a triple-card triple-standby mobile terminal.

10. A multi-card mobile terminal comprising:
an acquiring unit for acquiring system messages received by any user identity card from a network; and
a storing unit for storing the system messages acquired by the acquiring unit in a buffer, so that each user identity card acquires the system messages from the buffer.

11. The multi-card mobile terminal of claim 10, further comprising a first classifying unit for classifying the system messages before the system messages is stored and controlling the storing unit to store one kind of system messages only once.

12. The multi-card mobile terminal of claim 10, further comprising a setting unit for setting a period of validity for the system messages and a transmitting unit for transmitting the system messages to the user identity cards in the period of validity.

13. The multi-card mobile terminal of claim 11, wherein the user identity cards are SIM cards and the period of validity is five minutes.

14. The multi-card mobile terminal of claim 11, wherein if the period of validity has expired, the acquiring unit acquires real-time system messages received by any user identity card from the network, and the transmitting unit transmits the real-time system messages to the user identity cards.

15. The multi-card mobile terminal of claim 14, wherein the storing unit updates the system messages in the buffer according to the real-time system messages.

16. The multi-card mobile terminal of claim 15, wherein the updating of system messages comprises replacement or amendment.

17. The multi-card mobile terminal of claim 15, further comprising a second classifying unit for classifying the real-time system messages before the system messages is updated and controlling the storing unit to update one kind of system messages only once.

18. The multi-card mobile terminal of claim 10, wherein the multi-card mobile terminal is a triple-card triple-standby mobile terminal.
